(19) United States
(12) Patent Application Publication
(10) Pub. No.: US 2015/0261487 A1
(43) Pub. Date: Sep. 17, 2015

(54) PRINT JOB TRANSFER AND EXECUTION SYSYTEM, PRINT JOB TRANSFER AND EXECUTION METHOD, PRINT JOB TRANSFER SERVER, IMAGE FORMING APPARATUS, AND RECORDING MEDIUM

(71) Applicant: KONICA MINOLTA, INC., Tokyo (JP)

(72) Inventor: Masato FUJII, Nagaokakyo-shi (JP)

(73) Assignee: KONICA MINOLTA, INC., Tokyo (JP)

(21) Appl. No.: 14/659,481

(22) Filed: Mar. 16, 2015

(30) Foreign Application Priority Data
Mar. 17, 2014 (JP) 2014-053872

(51) Int. Cl. G06F 3/12

(52) U.S. Cl. CPC G06F 3/1268; G06F 3/1285

(57) ABSTRACT

A print job transfer and execution system includes: a terminal apparatus; a print job transfer server; and one single or a plurality of image forming apparatuses, the foregoing server and apparatuses all being capable of accessing each other through a network; the terminal apparatus includes a transmitter that transmits a print job transfer request; the print job transfer server includes: a receiver that receives the print job transfer request; and a transfer portion that transfers a print job to the one single or any one of the image forming apparatuses along with a command for turning on a no count mode; the one single or each image forming apparatus includes: a counter that determines a usage level; a receiver that receives the print job along with the command; a mode switch that selects the no count mode; and a printer that executes the print job in the no count mode.

This application claims priority under 35 U.S.C. §119 to Japanese Patent Application No. 2014-053872 filed on Mar. 17, 2014, the entire disclosure of which is incorporated herein by reference in its entirety.

### BACKGROUND OF THE INVENTION

1. Field of the Invention

The present invention relates to a print job transfer and execution system in which a print job transfer server transfers a print job to an image forming apparatus and the image forming apparatus executes the print job; a print job transfer and execution method for the print job transfer and execution system; the print job transfer server; the image forming apparatus; and a non-transitory computer-readable recording medium storing a print control program.

2. Description of the Related Art

The following description sets forth the inventor's knowledge of related art and problems therein and should not be construed as an admission of knowledge in the prior art.

In recent years, there have been print job transfer and execution systems each in which: a user terminal apparatus transmits a print job transfer request to a print job transfer server through the Internet; the print job transfer server transfers a print job to a specified image forming apparatus as a delivery address upon receiving the print job transfer request; and the specified image forming apparatus executes the print job.

Such conventional print job transfer and execution systems achieve in providing an all-in-one print delivery service which allows sender users to specify such as different print settings or the number of prints depending on the delivery address, which is totally different from a broadcast facsimile service. Such an all-in-one print delivery service also allows target users to receive prints without the need for any action.

Meanwhile, image forming apparatuses are commonly equipped with a counter that determines a usage level in order to bill fees for its services. When an image forming apparatus executes a print job in a conventional print job transfer and execution system as described above, its counter automatically includes the print job in the count, which can cause a problem as described below.

That is, for example, there are advertisers who hope to use such an all-in-one print delivery service as described above to deliver print advertisements to target users while the target users receive them for free of charge.

Advertisers may use such a service in a conventional print job transfer and execution system as described above; in such a case, when an image forming apparatus executes a print job, its counter automatically includes the print job in the count and a fee for the print job is thus billed to target users who receive prints. This is an unsolved problem.

To solve this problem, fees can be adjusted before billing. For example, Japanese Patent No. 5223648 discloses a technique of: subtracting the number of transmitted pages, which is received from a content server, from the counter's value obtained by the image forming apparatus; and adjusting fees with the calculated value before billing.

Japanese Unexamined Patent Publication No. 2007-331113 discloses a technique of disabling the counter upon receipt of print data of a predetermined type such as user manual.

Japanese Unexamined Patent Publication No. 2003-251889 discloses a technique of providing a counter that counts the number of pages output as a paid service and a counter that counts the number of pages output as a free service and managing these counters separately.

Actually there is another problem with the technique disclosed by Japanese Patent No. 5223648: it is confusing or inconvenient to target users who receive prints that they will find a discrepancy between the counter's value and the amount due (the adjusted bill). Furthermore, this technique requires a print job transfer apparatus and a print job execution apparatus perform frequent communications to each other, making the system configuration too complicated.

Similarly, the technique of disabling the counter upon receipt of print data of a predetermined type, which is disclosed in Japanese Unexamined Patent Publication No. 2007-331113, has another problem: it is inconvenient that the counter can be disabled upon receipt of print data of only a predetermined type and it is troublesome to set a print data format to the condition and change the condition.

Similarly, the technique of managing different counters separately, which is disclosed in Japanese Unexamined Patent Publication No. 2003-251889, will not be later needed anymore because of changes in technology on the billing system.

### SUMMARY OF THE INVENTION

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

A first aspect of the present invention relates to a print job transfer and execution system including: a terminal apparatus; a print job transfer server; and one single or a plurality of image forming apparatuses, the terminal apparatus, the print transfer server, and the one single or the plurality of image forming apparatuses being capable of accessing each other through a network,

the terminal apparatus including a transmitter that transmits a print job transfer request to the print job transfer server, the request requesting to transfer a print job to the one single or any one of the image forming apparatuses, the print job to be executed in a no count mode for disabling a counter of the one single or the any one image forming apparatus,

the print job transfer server including:

a first receiver that receives the print job transfer request from the terminal apparatus; and

a transfer portion that transfers the print job to the one single or the any one image forming apparatus along with a command for turning on the no count mode upon the print job transfer request being received by the first receiver,

the one single or each image forming apparatus including:

the counter that determines a usage level;

a second receiver that receives the print job from the print job transfer server along with the command for turning on the no count mode;

a mode switch that selects the no count mode upon the print job being received by the second receiver along with the command for turning on the no count mode; and

a printer that executes the print job in the no count mode selected by the mode switch.

A second aspect of the present invention relates to a print job transfer and execution method for a print job transfer and execution system including: a terminal apparatus; a print job transfer server; and one single or a plurality of image forming apparatuses, the terminal apparatus, the print transfer server, and the one single or the plurality of image forming apparatuses being capable of accessing each other through a network, the print job transfer and execution method including:

the following step for the terminal apparatus: transmitting a print job transfer request to the print job transfer server, the print job transfer request requesting to transfer a print job to the one single or any one of the image forming apparatuses, the print job to be executed in a no count mode for disabling a counter of the one single or the any one image forming apparatus;

the following steps for the print job transfer server:

receiving the print job transfer request from the terminal apparatus; and

transferring the print job to the one single or the any one image forming apparatus along with a command for turning on the no count mode upon the print job transfer request being received from the terminal apparatus,

the following steps for the one single or each image forming apparatus:

receiving the print job from the print job transfer server along with the command for turning on the no count mode;

selecting the no count mode upon the print job being received from the print job transfer server along with the command for turning on the no count mode; and

executing the print job in the no count mode being selected.

A third aspect of the present invention relates to a print job transfer server including:

a receiver that receives a print job transfer request from a terminal apparatus through a network, the print job transfer request requesting to transfer a print job to one single image forming apparatus or any one of a plurality of image forming apparatuses, the print job to be executed in a no count mode for disabling a counter of the one single or the any one image forming apparatus; and

a transfer portion that transfers the print job to the one single or the any one image forming apparatus through the network along with a command for turning on the no count mode upon the print job transfer request being received by the receiver.

A fourth aspect of the present invention relates to an image forming apparatus including:

a counter that determines a usage level;

a receiver that receives a print job from a print job transfer server along with a command for turning on a no count mode for disabling the counter;

a mode switch that selects the no count mode upon the print job being received by the receiver along with the command for turning on the no count mode; and

a printer that executes the print job in the no count mode selected by the mode switch.

A fifth aspect of the present invention relates to a non-transitory computer-readable recording medium storing a print control program for making a computer of an image forming apparatus execute:

receiving a print job from a print job transfer server along with a command for turning on a no count mode for disabling a counter of the image forming apparatus, the counter determining a usage level;

selecting the no count mode upon the print job being received from the print job transfer server along with the command for turning on the no count mode; and

executing the print job in the no count mode being selected.

A sixth aspect of the present invention relates to a non-transitory computer-readable recording medium storing a print job transfer program for making a computer of a print job transfer server execute:

receiving a print job transfer request from a terminal apparatus through a network, the print job transfer request requesting to transfer a print job to one single image forming apparatus or any one of a plurality of image forming apparatuses, the print job to be executed in a no count mode for disabling a counter of the one single or the any one image forming apparatus; and

transferring the print job to the one single or the any one image forming apparatus through the network along with a command for turning on the no count mode upon the print job transfer request being received from the terminal apparatus.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying drawings, in which:

FIG. 1 illustrates a configuration of a print job transfer and execution system according to one embodiment of the present invention;

FIG. 2 is a block diagram illustrating a system configuration of a print job transfer server;

FIG. 3 is a block diagram illustrating a system configuration of an image forming apparatus;

FIG. 4 is a screen that allows a user to give a print job transfer request by operating a terminal apparatus;

FIG. 5 is a flowchart representing operations to be performed by a print job transfer server in response to a print job transfer request from the terminal apparatus;

FIG. 6 shows an example of a job ticket;

FIG. 7 is a flowchart representing operations to be performed by an image forming apparatus upon receipt of a print job from the print job transfer server;

FIG. 8 is a flowchart representing operations to be performed by the print job transfer server in another embodiment of the present invention;

FIG. 9 is a flowchart representing operations to be performed by the image forming apparatus upon receipt of a print job from the print job transfer server in the embodiment of FIG. 8; and

FIG. 10 shows an example of a PJL command for turning on a no count mode.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

Hereinafter, some embodiments of the present invention will be described with reference to the accompanying drawings.

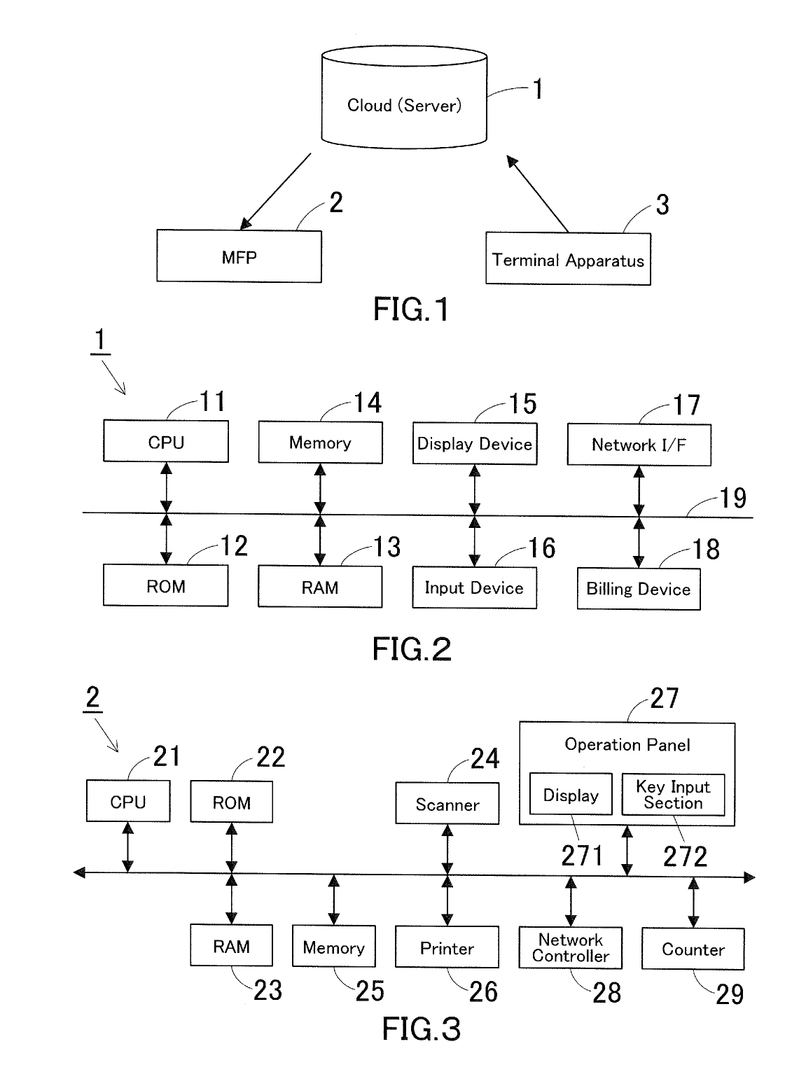

FIG. 1 illustrates a configuration of a print job transfer and execution system according to one embodiment of the present invention. The print job transfer and execution system is provided with: a print job transfer server 1 that is commonly referred to as a “cloud”; a plurality of image forming apparatuses 2; and a terminal apparatus 3 and these are capable of accessing each other through a network such as the Internet. The terminal apparatus 3 transmits to the print job transfer server 1 a print job transfer request requesting to transfer a print job to one or more specified ones of the image forming apparatuses 2 and the print job transfer server 1 then transfers a print job to the one or more specified image forming apparatuses 2.

The print job transfer server 1 is comprised of a personal computer, for example. FIG. 2 is a block diagram illustrating a system configuration of the print job transfer server 1.

As illustrated in FIG. 2, the print job transfer server 1 is provided with: a CPU 11; a ROM 12; a RAM 13; a memory 14; a display device 15; an input device 16; a network interface (network I/F) 17; a billing device 18; and others, all of which are connected to each other via a system bus 19.

The CPU 11 controls the entire print job transfer server 1 in a unified and systematic manner by executing a program stored on the ROM 12. Specifically, in this embodiment, the CPU 11 transfers a print job to a specified image forming apparatus 2 in response to a print job transfer request from the terminal apparatus 3. If the print job transfer request requests to transfer a print job to be executed in a no count mode for disabling a counter of the specified image forming apparatus 2, the CPU 11 bills a fee for the print job to the user of the terminal apparatus 3. This will be later described in details.

The ROM 12 is a recording medium that stores operation programs to be executed by the CPU 11 and other data.

The RAM 103 is a recording medium that provides a work area for the CPU 11 to perform processing in accordance with operation programs.

The memory 14 is comprised of a recording medium such as a hard disk drive; the memory 14 stores various data objects such as information on each image forming apparatus 2 as a delivery address, information on users of the terminal apparatus 3, print jobs received from the terminal apparatus 3, application software, and others.

The display device 15 is comprised of a CRT or liquid crystal display, for example; the display device 15 displays various messages, operation screens, and others.

The input device 16 is used for input by operators of the print job transfer server 1; the input device 16 is comprised of a keyboard, a mouse, and others.

The network interface 17 serves as a communicator that supports data communications with the image forming apparatus 2 and the terminal apparatus 3 on the network.

When the CPU 11 receives a print job transfer request to execute a print job in a no count mode from the terminal apparatus 3, the billing device 18 obtains the counter's value of the user who gave the print job transfer request by operating the terminal apparatus 3 and then bills a fee for the print job to the user.

In this embodiment, multi-function peripherals (MFPs), i.e., multifunctional digital image forming apparatuses each having various functions such as a copier function, a printer function, a scanner function, and a facsimile function are employed as the image forming apparatuses 2. Each of the image forming apparatuses 2 will be referred to as a “MFP 2” in the descriptions and drawings to de described below.

FIG. 3 is a block diagram illustrating a system configuration of the MFP 2. As illustrated in FIG. 3, the MFP 2 is provided with: a CPU 21; a ROM 22; a RAM 23; a scanner 24; a memory 25; a printer 26; an operation panel 27; a network controller 28; a counter 29; and others.

The CPU 21 controls the entire MFP 2 in a unified and systematic manner to allow users to use the basic functions of the MFP 2 such as a copier function, a printer function, a scanner function, and a facsimile function. Specifically, in this embodiment, the CPU 21 executes a print job upon receipt of it from the print job transfer server 1, and the CPU 21 then turns on a no count mode for disabling the counter 29 if the print job meets the condition for turning on a no count mode.

The ROM 22 is a recording medium that stores operation programs for the CPU 21 and other data.

The RAM 23 is a recording medium that provides a work area for the CPU 21 to perform processing in accordance with operation programs.

The scanner 24 is an image reader that scans images on a document put on a platen (not shown in this figure) to obtain image data.

The memory 25 is comprised of a non-volatile memory device such as a hard disk drive (HDD); the memory 25 stores: count information of the counter 29; a job history; document image data obtained by the scanner 24; print jobs received from the print job transfer server 1; data received from the terminal apparatus 3; and others.

The printer 26 prints document image data obtained by the scanner 24, print data received from user terminals, and others in a specified print mode.

The operation panel 27 serves for input for settings and instructions; the operation panel 27 is provided with: a display 271 that is comprised of, for example, a touch panel liquid-crystal display that displays messages and operation screens; and a key input section that is provided with a numeric keypad, a start key, a stop key, and other keys.

The network controller 28 controls data communications with external apparatuses on the network such as the print job transfer server 1, the terminal apparatus 3, and other image forming apparatuses 2.

The counter 29 determines a usage level on each user by counting the number of pages copied or printed, for example, so that fees can be billed.

The terminal apparatus 3 is comprised of a personal computer; the terminal apparatus 3 transmits a print job transfer request to the print job transfer server 1. The print job transfer server 1 of FIG. 2 has a similar system configuration to that of the terminal apparatus 3 with the exception of the billing device 18; an explanation on the system configuration of the terminal apparatus 3 will be omitted. The terminal apparatus 3 may alternatively be a portable terminal such as a smartphone.

Hereinafter, operations of the print job transfer and execution system of FIG. 1 will be described in details.

In this system, a user gives a print job transfer request to the print job transfer server 1 by operating the terminal apparatus 3.

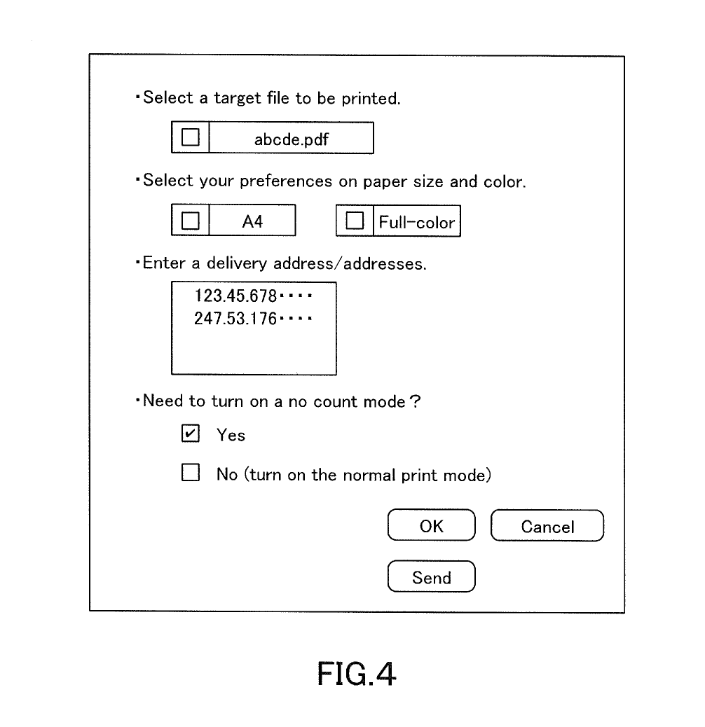

FIG. 4 is a screen that allows a user to give a print job transfer request by operating the terminal apparatus 3.

Via the screen, the user specifies a target file, a paper size, full-color or monochrome, and a MFP 2 to print the target file, i.e., a MFP 2 as a delivery address to which a print job is transferred. The target file may be stored in a folder of the terminal apparatus 3, may be stored in advance on the memory 14 of the print job transfer server 1, or may be stored in another external apparatus.

The user may specify a MFP 2 by inputting IP address information or by selecting from a list of available MFPs displayed on the screen, which is obtained from information registered on the print job transfer server 1.

In this embodiment, a command for turning on a no count mode can be given to a print job to be transferred. Without such a command, the MFP 2 executes a print job in the normal print mode and the counter 29 of the MFP 2 includes the print job in the count. A fee for the print job is thus billed to the target user who receives a print at the delivery address. In contrast, with a command for turning on a no count mode, the MFP 2 executes a print job in a no count mode and the counter 29 of the MFP 2 does not include the print job in the count. A fee for the print job is thus billed to the user who gave a print job transfer request by operating the terminal apparatus 3, by the billing device 18 of the print job transfer server 1.

There are advertisers who hope to use and pay for an advertising service to deliver print advertisements such as leaflets to target users by operating the terminal apparatus 3 while the target users receive them from the MFPs 2 for free of charge. To achieve such an advertising service, this embodiment is configured such that a print job can be executed in a no count mode.

A user presses an OK button to fix a print job transfer request then a transmit button via the screen of FIG. 4 on the terminal apparatus 3; the print job transfer request is transmitted to the print job transfer server 1.

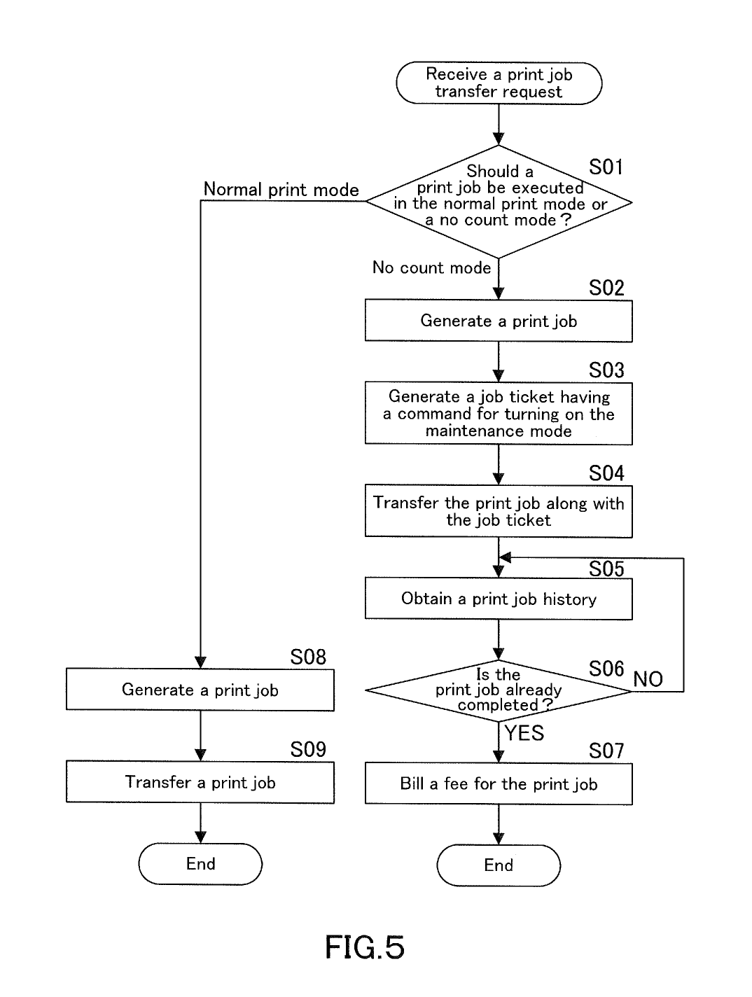

Hereinafter, operations to be performed by the print job transfer server 1 in response to the print job transfer request from the terminal apparatus 3 will be described in details with reference to the flowchart of FIG. 5. The flowchart is executed by the CPU 11 of the print job transfer server 1 in accordance with an operation program stored on a recording medium such as the ROM 12.

The flowchart starts with a receipt of a print job transfer request; it is judged in Step S01 whether a print job should be executed in the normal print mode or a no count mode. If a print job should be executed in a no count mode (“no count mode” in Step S01), a print job is generated in Step S02 and a job ticket having a command for turning on the maintenance mode is generated in Step S03. The maintenance mode is a no count mode, in which service persons, for example, normally perform maintenance checks on the MFP 2; in the no count mode, the counter 29 is disabled and users thus are able to avoid from billing to target users who receive prints.

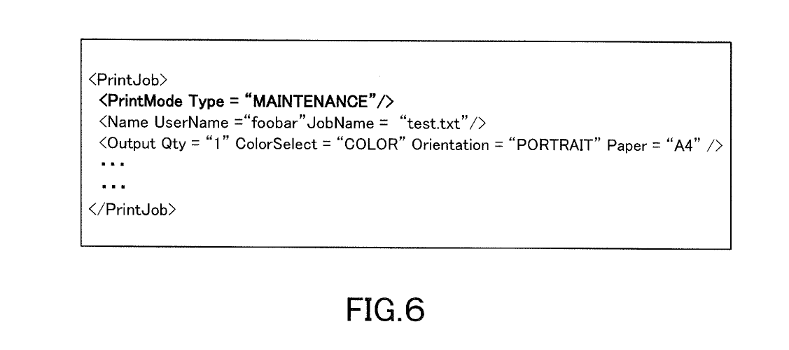

FIG. 6 shows an example of the job ticket generated in this step. The job ticket gives an instruction to turn on the maintenance mode by the following command: PrintMode Type=“MAINTENANCE”. The job ticket also has a command for turning on the full-color print mode and other commands.

Back to FIG. 5, in Step S04, the print job and the job ticket are transferred to a specific MFP 2 that is a delivery address indicated by the print job transfer request received from the terminal apparatus 3. In Step S05, a print job history is obtained from the MFP 2; then it is judged in Step S06 whether or not the print job is already completed by the MFP 2. If it is not completed yet (NO in Step S06), the routine returns to Step S05 to repeat Steps S05 and S06.

If the print job is already completed by the MFP 2 (YES in Step S06), then in Step S07, a fee for the print job is billed to the user who gave the print job transfer request by operating the terminal apparatus 3.

Back to Step S01, if a print job should be executed in the normal print mode (“normal print mode” in Step S01), a print job is generated in Step S08 and the print job is transferred in Step S09.

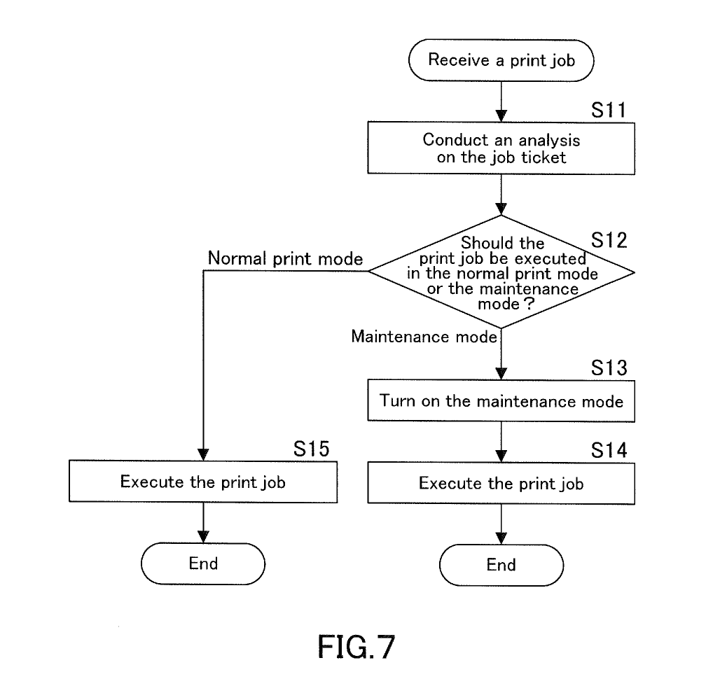

Hereinafter, operations to be performed by the MFP 2 upon receipt of a print job from the print job transfer server 1 will be described in details with reference to the flowchart of FIG. 7. The flowchart is executed by the CPU 21 of the MFP 2 in accordance with an operation program stored on a recording medium such as the ROM 22.

The flowchart starts with a receipt of a print job by the MFP 2; an analysis is conducted on a job ticket in Step S11 then it is judged in Step S12 whether or not the print job should be executed in the normal print mode or the maintenance mode. Job tickets are generated only in a no count mode in this embodiment; without a job ticket, it is therefore judged that the print job should be executed in the normal print mode (“normal print mode” in Step S12); the print job is then executed in Step S15, accordingly. The counter 29 includes the print job in the count and a fee for the print job is thus billed to the user of the MFP 2.

In Step S12, if the print job should be executed in the maintenance mode (“maintenance mode” in Step S12), the maintenance mode that is a no count mode is turned on in Step S13 and the print job is executed in Step S14. The print job is executed in the maintenance mode; the counter 29 does not include the print job in the count and a fee for the print job is thus not billed to the user of the MFP 2.

As described above, in this embodiment, the terminal apparatus 3 transmits a print job transfer request requesting to transfer a print job to be executed in a no count mode and the print job transfer server 1 then transfers a print job to the MFP 2 along with a command for turning on the maintenance mode. The MFP 2 then executes the print job in the maintenance mode and the counter 29 of the MFP 2 does not include the print job in the count; thus it is not confusing or inconvenient anymore to target users who receive prints because they will not find a discrepancy between the counter's value and the amount due. The maintenance mode is a common and ordinary function installed on the MFP 2: there is no need for changing the system configuration and it is independent of print data format. With a simple configuration of the MFP 2, users anytime can use the delivery service in a reliable manner while target users receive prints for free of charge.

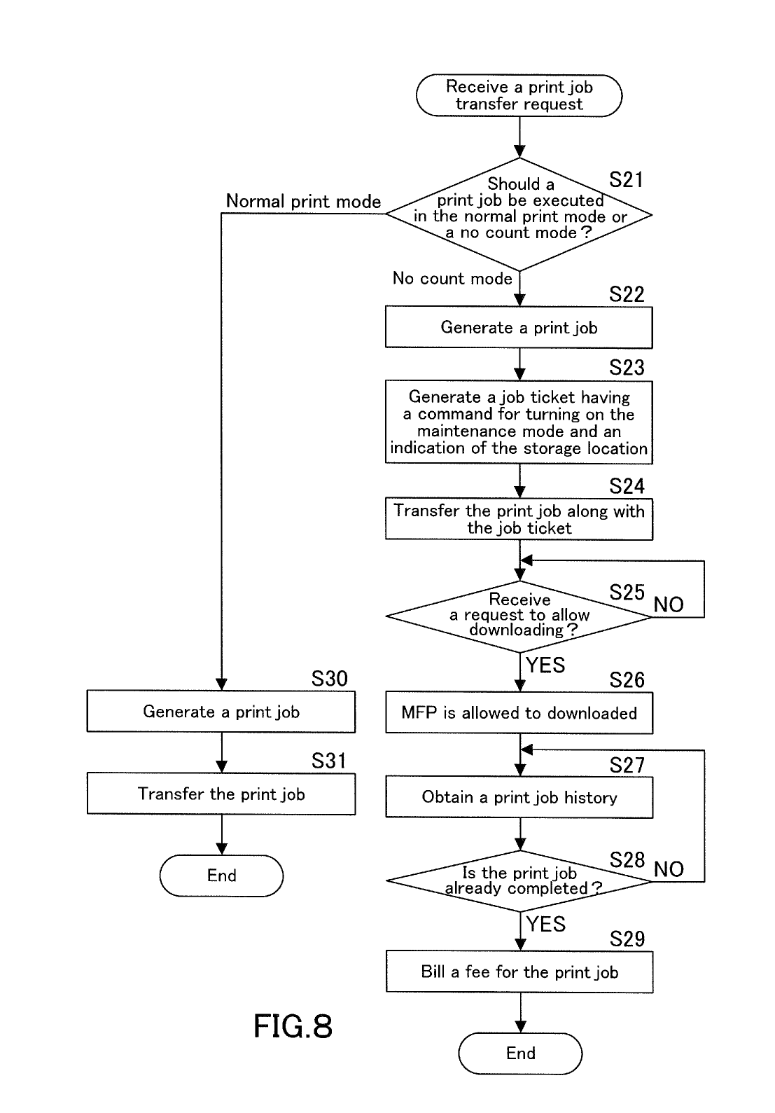

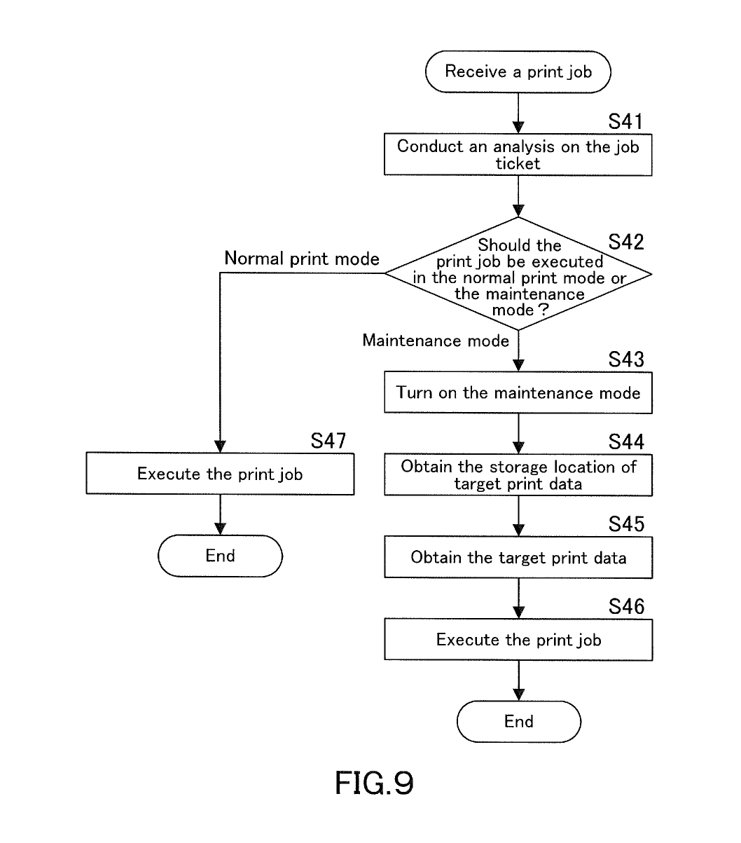

FIGS. 8 and 9 illustrate another embodiment of the present invention. In this embodiment, the terminal apparatus 3 transmits a print job transfer request and target print data to the print job transfer server 1 and, upon receipt of the print job transfer request, the print job transfer server 1 stores the target print data on the memory 14. A job ticket has a command for turning on the maintenance mode and an indication of the storage location of the target print data. The print job transfer server 1 then transfers this job ticket to a specific MFP 2 that is a delivery address indicated by the print job transfer request.

FIG. 8 is a flowchart representing the above-described operations to be performed by the print job transfer server 1. The flowchart is executed by the CPU 11 of the print job transfer server 1 in accordance with an operation program stored on a recording medium such as the ROM 12.

The flowchart starts with a receipt of a print job transfer request; it is judged in Step S21 whether a print job should be executed in the normal print mode or a no count mode. If a print job should be executed in a no count mode (“no count mode” in Step S21), a print job is generated in Step S22 and a job ticket having a command for turning on the maintenance mode is generated in Step S23. Furthermore, target print data is stored on the memory 14 and the storage location of the target print data is written to the job ticket.

Back to Step S24, the print job and the job ticket are transferred to a specific MFP 2 that is a delivery address indicated by the print job transfer request received from the terminal apparatus 3. In Step S25, the routine waits until a request to allow downloading the target print data is received from the MFP 2 (NO in Step S25).

If a request to allow downloading the target print data is received (YES in Step S25), the MFP 2 is allowed to download the target print data in Step S26 and a print job history is obtained from the MFP 2 in Step S27. Then it is judged in Step S28 whether or not the print job is already completed by the MFP 2. If it is not completed yet (NO in Step S28), the routine returns to Step S27 to repeat Steps S27 and S28.

If the print job is already completed by the MFP 2 (YES in Step S28), then in Step S29, a fee for the print job is billed to the user who gave the print job transfer request by operating the terminal apparatus 3.

Back to Step S21, if a print job should be executed in the normal print mode (“normal print mode” in Step S21), a print job is generated in Step S30 and the print job is transferred in Step S31.

Hereinafter, operations to be performed by the MFP 2 upon receipt of a print job from the print job transfer server 1 will be described in details with reference to the flowchart of FIG. 9. The flowchart is executed by the CPU 21 of the MFP 2 in accordance with an operation program stored on a recording medium such as the ROM 22.

The flowchart starts with a receipt of a print job by the MFP 2; an analysis is conducted on a job ticket in Step S41 then it is judged in Step S42 whether or not the print job should be executed in the normal print mode or the maintenance mode. Job tickets are generated only in a no count mode in this embodiment; without a job ticket, it is therefore judged that the print job should be executed in the normal print mode (“normal print mode” in Step S42); the print job is then executed in Step S47, accordingly. The counter 29 includes the print job in the count and a fee for the print job is thus billed to the user of the MFP 2.

In Step S42, if the print job should be executed in the maintenance mode (“maintenance mode” in Step S42), the maintenance mode that is a no count mode is turned on in Step S43. Subsequently, an analysis is further conducted on the job ticket to obtain the storage location of target print data in Step S44. The target print data is obtained from the print job transfer server 1 in Step S45 and the target print data is printed in Step S46. The print job is executed in the maintenance mode; the counter 29 does not include the print job in the count and a fee for the print job is thus not billed to the user of the MFP 2.

As described above, in this embodiment, the terminal apparatus 3 transmits a print job transfer request that requests to transfer a print job to be executed in a no count mode and the print job transfer server 1 then transfers a print job to the MFP 2 along with a command for turning on the maintenance mode. The MFP 2 obtains target print data from the print job transfer server 1, i.e., from the storage location of the target print data. The MFP 2 then executes the print job in the maintenance mode and the counter 29 of the MFP 2 does not include the print job in the count; it is not confusing or inconvenient anymore to target users who receive prints because they will not find a discrepancy between the counter's value and the amount due. The maintenance mode is a common and ordinary function installed on the MFP 2: there is no need for changing the system configuration and it is independent of print data format. Users therefore can avoid from billing to target users who receive prints, in an easy and reliable manner when the need arises.

In the embodiment described with reference to FIGS. 8 and 9, the terminal apparatus 3 transmits target print data to the print job transfer server 1 along with a print job transfer request and the print job transfer server 1 receives and stores the target print data on the memory 14. The embodiment alternatively may be configured such that target print data is stored in advance on the memory 14; in such a configuration, the user of the terminal apparatus 3 gives a print job transfer request along with an indication of the storage location of the target print data. The target print data alternatively may be stored in a different apparatus than the print job transfer server 1.

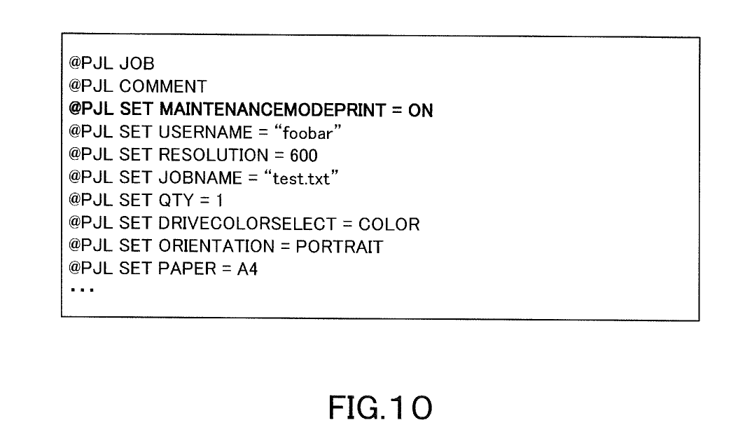

While two embodiments of the present invention have been described in details herein it should be understood that the present invention is not limited to the foregoing embodiments. A job ticket has a command for turning on the maintenance mode in the above-described embodiments; a print job language (PJL) description alternatively may have such a command as illustrated in FIG. 10. In the example of FIG. 10, a PJL description gives an instruction to turn on the maintenance mode by the following command: ©PJL SET MAINTENANCEMODEPRINT=ON.

In the above-described embodiments, the print job transfer server 1 transfers a print job to the MFP 2 along with a command for turning on the maintenance mode that is a no count mode and the MFP 2 executes the print job in the maintenance mode in accordance with the command. These embodiments alternatively may be configured such that the print job transfer server 1 transfers a print job to the MFP 2 along with a command for turning on a no count mode, not the maintenance mode, and the MFP 2 executes the print job in a no count mode, e.g., the maintenance mode if it is judged that the print job is received along with a command for turning on a no count mode.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. A print job transfer and execution system comprising: a terminal apparatus; a print job transfer server; and one single or a plurality of image forming apparatuses, the terminal apparatus, the print transfer server, and the one single or the plurality of image forming apparatuses being capable of accessing each other through a network,
the terminal apparatus comprising a transmitter that transmits a print job transfer request to the print job transfer server, the request requesting to transfer a print job to the one single or any one of the image forming apparatuses, the print job to be executed in a no count mode for disabling a counter of the one single or the any one image forming apparatus,
the print job transfer server comprising:
a first receiver that receives the print job transfer request from the terminal apparatus; and
a transfer portion that transfers the print job to the one single or the any one image forming apparatus along with a command for turning on the no count mode upon the print job transfer request being received by the first receiver,
the one single or each image forming apparatus comprising:
the counter that determines a usage level;
a second receiver that receives the print job from the print job transfer server along with the command for turning on the no count mode;
a mode switch that selects the no count mode upon the print job being received by the second receiver along with the command for turning on the no count mode; and
a printer that executes the print job in the no count mode selected by the mode switch.

2. The print job transfer and execution system as recited in claim 1, wherein the command for turning on the no count mode is provided by a job ticket, the command being received from the print job transfer server.

3. The print job transfer and execution system as recited in claim 1, wherein the command for turning on the no count mode is provided by a PJL description, the command being received from the print job transfer server.

4. The print job transfer and execution system as recited in claim 1, wherein: the command for turning on the no count mode is provided by a job ticket, the job ticket including an indication of a storage location of target print data, the command being received from the print job transfer server; and the printer of the one single or the each image forming apparatus obtains the target print data from the storage location indicated in the job ticket in preparation for executing the print job.

5. The print job transfer and execution system as recited in claim 1, wherein the no count mode selected by the mode switch of the one single or the each image forming apparatus is a maintenance mode.

6. The print job transfer and execution system as recited in claim 1, wherein the print job transfer server further comprises a billing device that bills a fee for the print job to a user having given the print job transfer request by operating the terminal apparatus.

7. The print job transfer and execution system as recited in claim 6, wherein the billing device bills the fee to the user upon the print job being completed by the one single or the any one image forming apparatus.

8. The print job transfer and execution system as recited in claim 7, wherein:
the print job transfer server further comprises a job history obtaining portion that obtains a job history from the one single or the any one image forming apparatus; and
it is judged whether or not the print job is already completed on the basis of the job history obtained by the job history obtaining portion.

9. A print job transfer and execution method for a print job transfer and execution system comprising: a terminal apparatus; a print job transfer server; and one single or a plurality of image forming apparatuses, the terminal apparatus, the print transfer server, and the one single or the plurality of image forming apparatuses being capable of accessing each other through a network, the print job transfer and execution method comprising:
the following step for the terminal apparatus: transmitting a print job transfer request to the print job transfer server, the print job transfer request requesting to transfer a print job to the one single or any one of the image forming apparatuses, the print job to be executed in a no count mode for disabling a counter of the one single or the any one image forming apparatus;
the following steps for the print job transfer server:
receiving the print job transfer request from the terminal apparatus; and
transferring the print job to the one single or the any one image forming apparatus along with a command for turning on the no count mode upon the print job transfer request being received from the terminal apparatus,
the following steps for the one single or each image forming apparatus:
receiving the print job from the print job transfer server along with the command for turning on the no count mode;
selecting the no count mode upon the print job being received from the print job transfer server along with the command for turning on the no count mode; and
executing the print job in the no count mode being selected.

10. A print job transfer server comprising:
a receiver that receives a print job transfer request from a terminal apparatus through a network, the print job transfer request requesting to transfer a print job to one single image forming apparatus or any one of a plurality of image forming apparatuses, the print job to be executed in a no count mode for disabling a counter of the one single or the any one image forming apparatus; and
a transfer portion that transfers the print job to the one single or the any one image forming apparatus through the network along with a command for turning on the no count mode upon the print job transfer request being received by the receiver.

11. The print job transfer server as recited in claim 10, wherein the command for turning on the no count mode is provided by a job ticket.

12. The print job transfer server as recited in claim 10, wherein the command for turning on the no count mode is provided by a Ph description.

13. The print job transfer server as recited in claim 10, wherein: the command for turning on the no count mode is provided by a job ticket, the job ticket including an indication of a storage location of target print data; and the one single or the any one image forming apparatus obtains the target print data from the storage location indicated in the job ticket in preparation for executing the print job.

14. The print job transfer server as recited in claim 10, further comprising a billing device that bills a fee for the print job to a user having given the print job transfer request by operating the terminal apparatus.

15. The print job transfer server as recited in claim 14, wherein the billing device bills the fee to the user upon the print job being completed by the one single or the any one image forming apparatus.

16. The print job transfer server as recited in claim 15, further comprising a job history obtaining portion that obtains a job history from the one single or the any one image forming apparatus, wherein it is judged whether or not the print job is already completed on the basis of the job history obtained by the job history obtaining portion.

17. An image forming apparatus comprising:
a counter that determines a usage level;
a receiver that receives a print job from a print job transfer server along with a command for turning on a no count mode for disabling the counter;
a mode switch that selects the no count mode upon the print job being received by the receiver along with the command for turning on the no count mode; and
a printer that executes the print job in the no count mode selected by the mode switch.

18. The image forming apparatus as recited in claim 17, wherein the command for turning on the no count mode is provided by a job ticket, the command being received from the print job transfer server.

19. The image forming apparatus as recited in claim 17, wherein the command for turning on the no count mode is provided by a PDL description, the command being received from the print job transfer server.

20. The image forming apparatus as recited in claim 17, wherein:
the command for turning on the no count mode is provided by a job ticket, the job ticket including an indication of a storage location of the target print data, the command being received from the print job transfer server; and
the printer obtains the target print data from the storage location indicated in the job ticket in preparation for executing the print job.

21. The image forming apparatus as recited in claim 17, wherein the no count mode selected by the mode switch is a maintenance mode.

22. A non-transitory computer-readable recording medium storing a print control program for making a computer of an image forming apparatus execute:
receiving a print job from a print job transfer server along with a command for turning on a no count mode for disabling a counter of the image forming apparatus, the counter determining a usage level;
selecting the no count mode upon the print job being received from the print job transfer server along with the command for turning on the no count mode; and
executing the print job in the no count mode being selected.

23. The non-transitory computer-readable recording medium storing the print control program as recited in claim 22, wherein the no count mode being selected is a maintenance mode.

24. The non-transitory computer-readable recording medium storing the print control program as recited in claim 22, wherein:
the command for turning on the no count mode is provided by a job ticket, the job ticket including an indication of a storage location of target print data, the command being received from the print job transfer server; and
the target print data is obtained from the storage location indicated in the job ticket in preparation for execution of the print job.

25. A non-transitory computer-readable recording medium storing a print job transfer program for making a computer of a print job transfer server execute:
receiving a print job transfer request from a terminal apparatus through a network, the print job transfer request requesting to transfer a print job to one single image forming apparatus or any one of a plurality of image forming apparatuses, the print job to be executed in a no count mode for disabling a counter of the one single or the any one image forming apparatus; and
transferring the print job to the one single or the any one image forming apparatus through the network along with a command for turning on the no count mode upon the print job transfer request being received from the terminal apparatus.

26. The non-transitory computer-readable recording medium storing the print job transfer program as recited in claim 25, wherein the command for turning on the no count mode is provided by a job ticket.

27. The non-transitory computer-readable recording medium storing the print job transfer program as recited in claim 25, wherein the command for turning on the no count mode is provided by a PJL description.

28. The non-transitory computer-readable recording medium storing the print job transfer program as recited in claim 25, wherein:
the command for turning on the no count mode is provided by a job ticket, the job ticket including an indication of a storage location of target print data; and
the one single or the any one image forming apparatus obtains the target print data from the storage location indicated in the job ticket in preparation for executing the print job.

29. The non-transitory computer-readable recording medium storing the print job transfer program as recited in claim 25, the print job transfer program for further making the computer execute billing a fee for the print job to a user having given the print job transfer request by operating the terminal apparatus.

30. The non-transitory computer-readable recording medium storing the print job transfer program as recited in claim 29, wherein the fee is billed to the user upon the print job being completed by the one single or the any one image forming apparatus.

31. The non-transitory computer-readable recording medium storing the print job transfer program as recited in claim 30, the print job transfer program for further making the computer execute obtaining a job history from the one single or the any one image forming apparatus, wherein it is judged whether or not the print job is already completed on the basis of the job history obtained from the one single or the any one image forming apparatus.
